(19) United States
(12) Patent Application Publication
(10) Pub. No.: US 2012/0321322 A1
(43) Pub. Date: Dec. 20, 2012

(54) OPTICAL MICROPHONE

(75) Inventors: Lisa Lust, Minneapolis, MN (US); Daniel Youngner, Maple Grove, MN (US); Doug Carlson, Woodbury, MN (US)

(73) Assignee: Honeywell International Inc., Morristown, NJ (US)

(21) Appl. No.: 13/162,169

(22) Filed: Jun. 16, 2011

(51) Int. Cl. H04B 10/02

(52) U.S. Cl. 398/133

(57) ABSTRACT

Some embodiments relate to an optical microphone according to an example embodiment. The optical microphone includes a semiconducting laser. The semiconducting laser includes a p-n junction within a cavity. The optical microphone further includes an acoustic membrane that receives coherent light emitted from the semiconducting laser and directs reflected light back toward the semiconducting laser. During operation of the optical microphone, the acoustic membrane flexes in response to pressure waves. The phase of the reflected light is dependent upon a distance of the acoustic membrane from the semiconducting laser.

### TECHNICAL FIELD

Embodiments relate to a microphone. More specifically, embodiments relate to an optical microphone.

### BACKGROUND

Many existing commercial MEMs microphones sense acoustic pressure waves on a flexible diaphragm by using capacitive pick off techniques to measure capacitance. Most MEMs microphones typically require the diaphragm to be at least 1.5 mm×1.5 mm×1mm in size in order to attain a measurable capacitance.

In addition, most MEMs microphones usually require an additional area in order to accommodate an internal amplifier. The amount of additional area that is required to accommodate the internal amplifier typically depends on the complexity of the internal amplifier.

The voltage signals levels that are normally output from a MEMs microphone typically need to be enhanced in order to reach a sufficiently high level (i.e., millivolts) above the voltage signals levels that are associated with ambient noise.

### BRIEF DESCRIPTION OF THE DRAWINGS

Some embodiments are illustrated by way of examples, and not by way of limitations, in the FIGS. of the accompanying drawings.

FIG. 1 is a diagram illustrating an optical microphone according to an example embodiment.

FIG. 2 is a section view of the optical microphone shown in FIG. 1 taken along line 2-2.

FIG. 3 is an enlarged schematic section view illustrating a portion of the optical microphone shown in FIG. 2 where the acoustic membrane is at a one wave length distance from the aperture of the semiconducting laser.

FIG. 4 shows the enlarged schematic section view of FIG. 3 where the acoustic membrane is fluctuating due to exposure to acoustic pressure waves.

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The embodiments may be combined, other embodiments may be utilized, or structural, and logical changes may be made without departing from the scope of the present invention. The following detailed description is, therefore, not to be taken in a limiting sense, and the scope of the present invention is defined by the appended claims and their equivalents.

In this document, the terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In some embodiments, an optical microphone may be constructed by placing a reflective flexible membrane in close proximity to the aperture of a semiconducting laser (e.g., a Vertical Cavity Surface Emitting Laser (VCSEL) or a Distributed Feedback laser (DFB)). The optical microphone uses the laser's own p-n junction to monitor optical feedback from the reflective flexible membrane and directly outputs voltage levels that may fluctuate by millivolts during operation of the optical microphone.

The changes in p-n junction voltage correspond to the flexure induced on the reflective flexible membrane from acoustic pressure waves. This construction may enable production of ultra small microphones (e.g., 0.35 mm×0.35 mm×0.35 mm) and may not require internal amplification electronics.

In some embodiments, the optical microphone may include relatively fewer electronics and less complex MEMs structures thereby making the optical microphone relatively simple to construct.

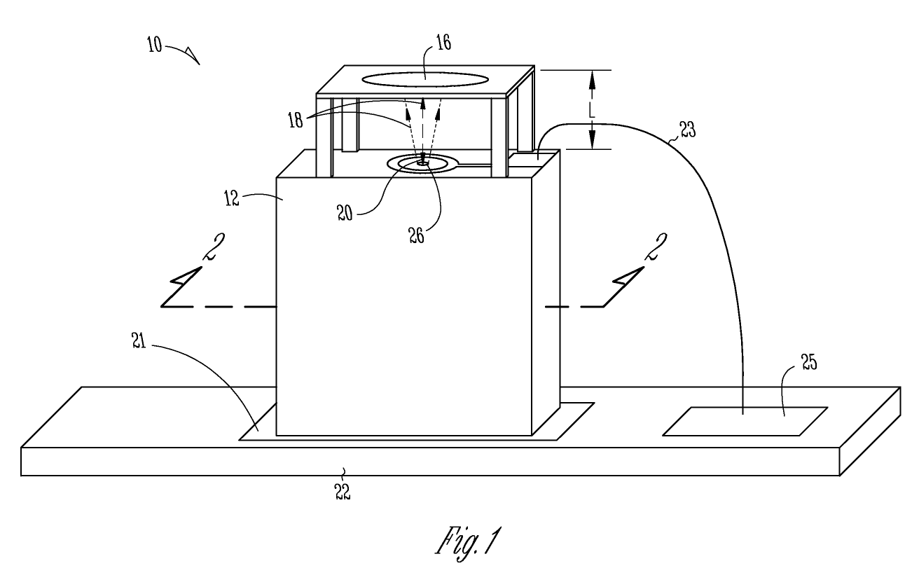

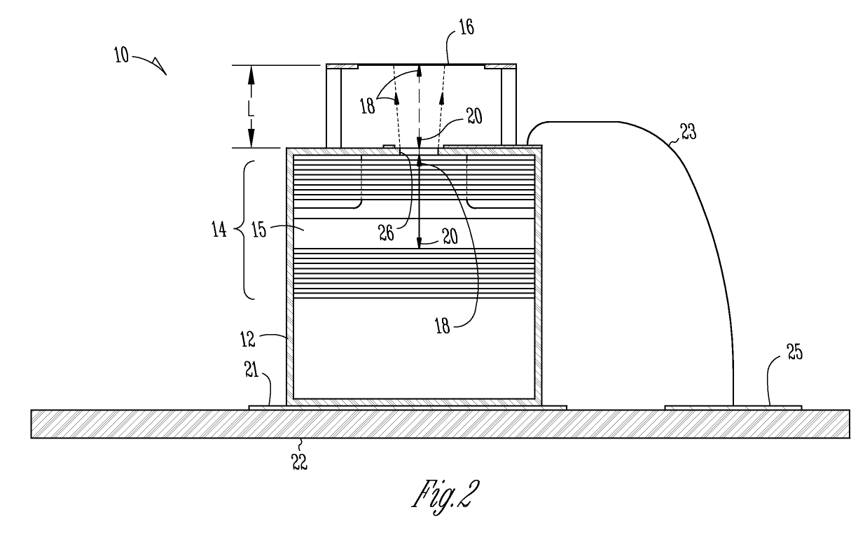

FIGS. 1 and 2 are diagrams illustrating an optical microphone 10 according to an example embodiment. The optical microphone 10 includes a semiconducting laser 12. The semiconducting laser 12 includes a p-n junction 14 within a cavity 15 of the semiconducting laser 12 (see FIG. 2). The optical microphone 10 further includes an acoustic membrane 16 that receives coherent light 18 emitted from the semiconducting laser 12 and directs reflected light 20 back toward the semiconducting laser 12.

During operation of the optical microphone 10, the acoustic membrane 16 flexes in response to acoustic pressure waves. The phase of the reflected light 20 is dependent upon a distance L of the acoustic membrane 16 from an aperture 26 of the semiconducting laser 12.

The type of semiconducting laser 12 that is utilized in the optical microphone 10 will be determined in part based on application requirements. As an example, a low power application would opt to use a semiconducting laser 12 which functions at low threshold currents and voltages. Some example lasers include diode lasers and vertical cavity surface emitting lasers (among other types of lasers that are known now or developed in the future).

As an example, the acoustic membrane 16 may be formed of silicon dioxide and may include a reflective layer formed of gold. In addition, the acoustic membrane 16 may include apertures to facilitate an appropriate amount of flexing during exposure to acoustic pressure waves.

In one example embodiment, the acoustic membrane 16 may be fabricated as part of a MEMs box with rigid silicon walls where the flexible acoustic membrane 16 is the cover of the box. As an example, the MEMs box may be processed directly over the semiconducting laser 12 such that the acoustic membrane 16 may be approximately several microns above the lasing aperture 26 (i.e., distance L in the FIGS.).

The acoustic membrane 16 may be at least moderately (or significantly) reflective at the wavelength of the coherent light 18 that is emitted by the semiconducting laser 12. The modulus of the acoustic membrane 16 may be critical to fabricating low distortion microphones under a wide dynamic range of sound levels.

In the example embodiment that is illustrated in FIGS. 1 and 2, the semiconducting laser 12 is surface mounted partially, or wholly, onto a ground pad 21 that is formed on a substrate 22. The semiconducting laser 12 may also be wire bonded to a bond pad 25 on the substrate 22 via a bonded wire 23. The bonded wire 23 is able to supply current from a current source to the semiconducting laser 12 in order to power the semiconducting laser 12 and also enable monitoring of the p-n junction 14 voltage.

In some embodiments, the current source supplies power to the semiconducting laser 12 until the semiconducting laser 12 is above a lasing threshold and a voltage is generated at the p-n junction 14 of the semiconducting laser 12. Operating the semiconducting laser 12 at the threshold current may be optimum because the optical feedback generates the largest change in the p-n junction voltage (ΔV).

The coherence of the reflected light 20 superimposed in with the emitted light 18 inside a cavity 15 of the semiconducting laser 12 depends on the phase shift that is introduced in the reflected light 20 by the round trip travel to and from the acoustic membrane 16. During operation of the optical microphone 10, the reflected light 20 undergoes phase changing as the acoustic membrane 16 fluctuates due to acoustic pressure waves acting on the acoustic membrane 16. The voltage level at the p-n junction 14 changes as the reflected light 20 mixes with the coherent light 18 in the cavity 15.

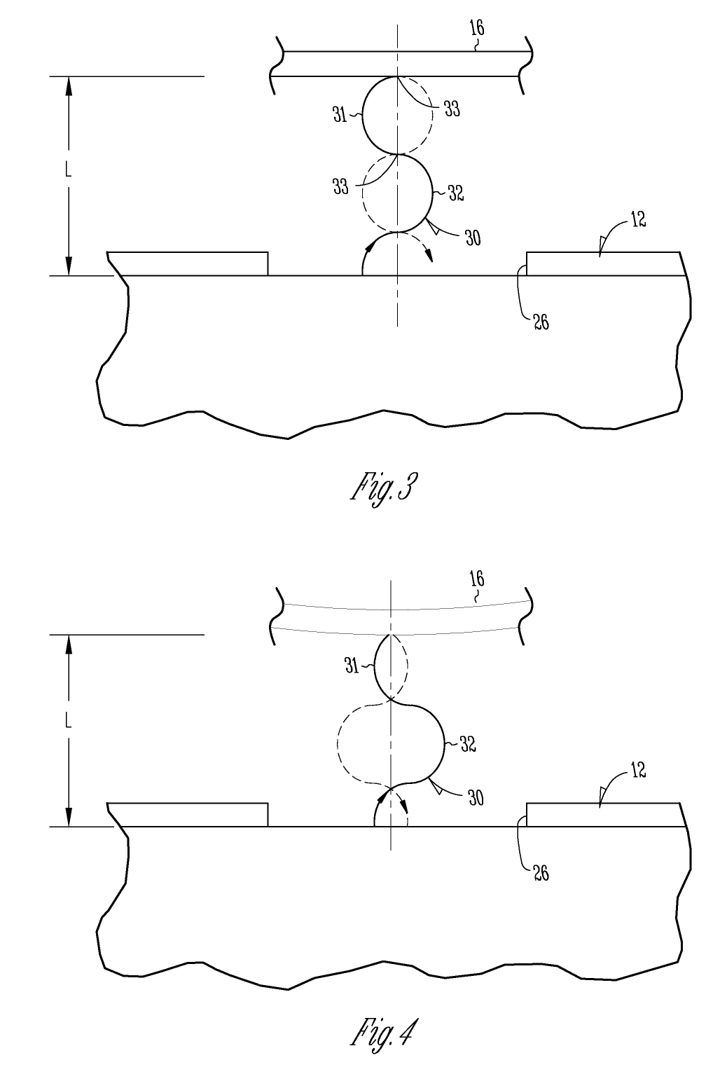

As shown in FIG. 3, the coherent light 18 is a sinusoidal light wave 30 that includes a maximum 31, a minimum 32 and a midpoint 33 between the maximum 31 and minimum 32. The acoustic membrane 16 is located at a distance L from the aperture 26 such that the sinusoidal light wave 30 reaches the acoustic membrane 16 at the midpoint 33 of the sinusoidal light wave 30. FIG. 3 shows the acoustic membrane 16 at a one wave length distance from the aperture 26. It should be noted that the acoustic membrane 16 may be located at any integral length distance of the sinusoidal light wave 30 from the aperture 26.

FIG. 4 shows the acoustic membrane 16 of FIG. 3 where the acoustic membrane 16 is fluctuating due to pressure waves. This fluctuation of the acoustic membrane 16 changes the distance L from the apertures 26 to the acoustic membranes 16 such that the midpoints 33 of the sinusoidal waves 30 no longer reach the respective acoustic membranes 16.

Therefore, the phase of the reentrant photons into the semiconducting laser 12 depends on the distance L to the acoustic membrane 16. In the equations below, τ, is the round trip propagation time, c is the speed of light, λ, is the wavelength, and η is a coupling coefficient which is related to the laser cavity parameters.

$$τ = \frac{2 L}{c} Δ V = η cos ( \frac{2 π c τ}{λ} ) = η cos ( \frac{4 π L}{λ} )$$

As the acoustic membrane 16 fluctuates due to acoustic pressure changes, the distance L to the acoustic membrane 16 thereby induces corresponding fluctuations in the p-n junction voltage. In embodiments where the acoustic membrane 16 is located at any integral length distance of the sinusoidal light wave 30 from the aperture 26, the voltage at the p-n junction 14 varies linearly in proportion to the acoustic membrane deflection 16.

In one example embodiment, during operation of the optical microphone 10 with sound under 70 dBSPL levels, the output of the optical microphone 10 without internal amplification using a commercial 1330 nm VCSELs was on the order of millivolts.

Other example embodiments relate to a method of converting acoustic pressure waves into voltage. The method includes using a semiconducting laser 12 to direct coherent light 18 toward an acoustic membrane 16. The method further includes using the acoustic membrane 16 to direct reflected light 20 back toward the semiconducting laser 12 to mix with the coherent light 18 within the semiconducting laser 12. This mixing causes a voltage level of a p-n junction 14 within the semiconducting laser 12 to change. As discussed above, during operation of the optical microphone 10, the reflected light 20 undergoes phase changing as the acoustic membrane 16 fluctuates due to acoustic pressure waves acting on the acoustic membrane 16.

The method may further include providing power to the semiconducting laser 12 with a current source such that when the semiconducting laser 12 is above a lasing threshold, a voltage is generated at the p-n junction 14. In some embodiments, providing power to the semiconducting laser 12 with a current source may include providing DC power to the semiconducting laser 12.

While there has been described herein the principles of the application, it is to be understood by those skilled in the art that this description is made only by way of example and not as a limitation to the scope of the application. Accordingly, it is intended by the appended claims, to cover all modifications of the application which fall within the true spirit and scope of the application.

1. An optical microphone comprising:
a semiconducting laser that includes a p-n junction within a cavity; and
an acoustic membrane that receives coherent light emitted from the semiconducting laser and directs reflected light back toward the cavity, the phase of the reflected light being dependent upon a distance of the acoustic membrane from the cavity.

2. The optical microphone of claim 1, wherein the semiconducting laser is a diode laser.

3. The optical microphone of claim 1, wherein the semiconducting laser is a vertical cavity surface emitting laser.

4. The optical microphone of claim 1, wherein the acoustic membrane flexes in response to pressure waves.

5. The optical microphone of claim 1, wherein the acoustic membrane is formed of silicon dioxide.

6. The optical microphone of claim 1, wherein the acoustic membrane includes a reflective layer formed of gold.

7. The optical microphone of claim 1, further comprising a current source for supplying power to the semiconducting laser such that when the semiconducting laser is above a lasing threshold, a voltage is generated at the p-n junction.

8. The optical microphone of claim 7, wherein the reflected light undergoes phase changing as the acoustic membrane fluctuates due to acoustic pressure waves acting on the acoustic membrane, and wherein the voltage at the p-n junction changes as the reflected light mixes with the coherent light in the cavity.

9. The optical microphone of claim 7, wherein the current source is a direct current source.

10. The optical microphone of claim 1, wherein the acoustic membrane includes apertures.

11. The optical microphone of claim 1, wherein the coherent light is a sinusoidal light wave that includes a maximum, a minimum and a midpoint between the maximum and the minimum, the acoustic membrane being located at a distance from the aperture such that the sinusoidal light wave reaches the acoustic membrane at the midpoint of the sinusoidal light wave.

12. The optical microphone of claim 11, wherein a voltage at the p-n junction varies linearly in proportion to the acoustic membrane deflection.

13. The optical microphone of claim 1, wherein the semiconducting laser is surface mounted onto a substrate.

14. The optical microphone of claim 13, further comprising a bond pad mounted on the substrate, the bonding pad providing a current input to power the semiconducting laser and an output for measuring a voltage at the p-n junction.

15. The optical microphone of claim 13, further comprising a ground pad mounted on the substrate such that the semiconducting laser is mounted onto ground pad.

16. A method of converting acoustic pressure waves into voltage, the method comprising:
using a semiconducting laser to direct coherent light toward an acoustic membrane; and
using the acoustic membrane to direct reflected light back toward the semiconducting laser to mix the reflected light with the coherent light within a cavity of the semiconducting laser such that a voltage level of a p-n junction within the semiconducting laser changes.

17. The method of claim 16, further comprising providing power to the semiconducting laser with a current source such that when the semiconducting laser is above a lasing threshold a voltage is generated at the p-n junction.

18. The method of claim 17, wherein providing power to the semiconducting laser with a current source include providing DC power to the semiconducting laser.

19. The method of claim 16, wherein the reflected light undergoes phase changing as the acoustic membrane fluctuates due to acoustic pressure waves acting on the acoustic membrane.

20. An optical microphone comprising:
a vertical cavity surface emitting laser that includes a p-n junction within a cavity;
an acoustic membrane that receives coherent light emitted from the vertical cavity surface emitting laser and directs reflected light back toward the cavity, the phase of the reflected light being dependent upon a distance of the acoustic membrane from the vertical cavity surface emitting laser; wherein the acoustic membrane flexes in response to pressure waves; and
a direct current source for supplying power to the vertical cavity surface emitting laser such that when the semiconducting laser is above a lasing threshold a voltage is generated at the p-n junction, wherein the reflected light undergoes phase changing as the acoustic membrane fluctuates due to acoustic pressure waves acting on the acoustic membrane, and wherein the voltage at the p-n junction changes as the reflected light mixes with the coherent light in the cavity of the vertical cavity surface emitting laser.

21. The optical microphone of claim 20, wherein the coherent light is a sinusoidal light wave that includes a maximum, a minimum and a midpoint between the maximum and the minimum, the acoustic membrane being located at a distance from the vertical cavity surface emitting laser such that the sinusoidal light wave reaches the acoustic membrane at the midpoint of the sinusoidal light wave, and wherein a voltage at the p-n junction varies linearly in proportion to the acoustic membrane deflection.
